(19) United States
(12) Patent Application Publication
(10) Pub. No.: US 2013/0122270 A1
(43) Pub. Date: May 16, 2013

(54) Composite Material For Lining Of Automotive Parts

(71) Applicants: Joseph S. George, West Bloomfield, MI (US); Thomas M. Derengowski, Charlevoix, MI (US); Jérôme Lefèvre, Schwerzenbach (CH)

(72) Inventors: Joseph S. George, West Bloomfield, MI (US); Thomas M. Derengowski, Charlevoix, MI (US); Jérôme Lefèvre, Schwerzenbach (CH)

(73) Assignee: QUADRANT PLASTIC COMPOSITES AG, Lenzburg (CH)

(21) Appl. No.: 13/297,340

(22) Filed: Nov. 16, 2011

(51) Int. Cl. B32B 7/02; B21D 39/03; B32B 37/10; B29C 43/18; B32B 38/00

(52) U.S. Cl. 428/216; 264/266; 156/245; 29/428

(57) ABSTRACT

The invention relates to a composite material for lining of automotive parts, comprising a carrier layer made of a porous, fiber reinforced polyolefin and a decorative skin made of a deep-drawable amorphous thermoplastic, preferably TPO.

### BACKGROUND OF THE INVENTION

1. Field of the Invention

The invention relates to a composite material comprising a carrier layer A made of a porous, fiber reinforced polyolefin A and a decorative skin B made of a deep-drawable amorphous thermoplastic, to the production of such composite material and to the use thereof for lining of automotive parts.

2. Description of the Related Art

Automotive outer parts, particularly bumpers, are generally made of visually un-attractive material, e.g. of steel, aluminum or glass-fiber reinforced polypropylene (GMT). These materials generally do not have sufficient elasticity to withstand collisions without damage. In particular, metals are not weather proof and not resistant to chemicals so that such parts are preferably lined with decorative materials. These are predominantly composite materials made of a compact inner layer and a decorative outer layer. The inner layer is usually an injection molded part made of a thermoplastic which comprises filler materials. A disadvantage of such parts is that they are relatively heavy and also susceptible to cracking and to shocks. Moreover, they have a relatively large thermal expansion.

For the lining of automotive inner parts, composite materials made of extruded polyolefin foamed plastics and decorative skins made of a blend of polypropylene and an EPDM rubber (so called thermoplastic olefin or TPO foils) have also been proposed. However, these composite materials have a poor rigidity and tear resistance. Moreover, they have too large a thermal expansion for lining of steel parts, so that they are only useful for the lining of automotive outer parts when used in combination with auxiliary materials.

### SUMMARY OF THE INVENTION

Therefore, it was an object of the present invention to provide a composite material, especially for the lining of automotive outer parts which is free of the drawbacks mentioned above. These and other objects are achieved by providing composite materials having a carrier layer of porous, fiber reinforced polyolefin, and a decorative skin of a deep-drawable thermoplastic.

### DETAILED DESCRIPTION OF THE PREFERRED EMBODIMENTS

According to one aspect of the present invention, there is provided a composite material comprising the following layers:

A. a carrier layer made of a porous, fiber reinforced polyolefin with a thickness of 1 to 6 mm, and

B. a decorative skin made of a deep-drawable thermoplastic with a thickness of 0.5 to 5 mm.

The following amorphous thermoplastics are preferably used for layer B:

a blend of a polyolefin and an EPDM rubber (TPO),
an acrylonitrile butadiene styrene copolymer (ABS),
a styrene acrylonitile copolymer (SAN),
a polycarbonate (PC),
polymethyl methacrylate (PMMA),
a polyvinyl chloride (PVC)

The carrier layer A preferably consists of a polypropylene matrix containing 20 to 60 wt.-%, particularly 30 to 50 wt.-%, glass fibers that are homogeneously distributed in the matrix, with the latter having an air void content of 20 to 80 vol.-%, preferably 30 to 60 vol.-%. Preferably, the thickness of carrier layer A is 2 to 4 mm. Such materials have been described, for example, in WO 2006/105 682 and can be purchased, e.g., as SYMALITE of Quadrant Plastic Composites AG, SEEBERLITE of Rochling Automotive AG, SUPERLITE of HanWha, and ACOUSTIMAX of Owens Corning Corp. The carrier layer A is comparatively rigid in spite of its low specific weight, and it is thermoplastically moldable.

The decorative skin B preferably consists of a blend of 95 to 50 wt.-%, particularly 90 to 70 wt.-% polypropylene and 5 to 50 wt.-%, particularly 10 to 30 wt.-% of an ethylene propylene diene monomer (EPDM) rubber. The thickness of the decorative skin or foil is preferably 1 to 4 mm. The raw material for this kind of decorative skin is sold under the designation TPO by the companies Mytex and Nobel Polymers. If compared with foils made of other amorphous thermoplastics, TPO foils are very elastic and thus return to their original state after deformation. Therefore, they are preferred for the purposes of the present invention.

The decorative skin B is characterized by a smooth surface; it can be pigmented or dyed, and thus can be adapted to an automobile's color. The skin B can also be coated with a protective film, for example based on a polyurethane or an acrylic resin, in order to impart scratch or weather resistance to the automotive part. The coating preferably is 5 to 100 μm thick; it can be applied to the skin B by spraying or calendering.

If the composite materials of the present invention have non-planar contours, they can be manufactured in a two-step or in a one-step process.

In the two-step process, a decorative skin is first formed by heating (preferably 30 to 240 sec at 180 to 200° C.) and placing it into a mold half having the desired contours upon heating. This is preferably done by means of deep-drawing. Subsequently, the carrier layer which was heated up to the melting temperature of the polyolefin is draped over it. In the case of polypropylene, this is preferably in the range of 150 to 180° C. Thereafter, the mold is closed and the composite material is formed by pressing at a tool temperature of 40 to 90° C. and an internal pressure of 1 to 5 bar. After cooling, the composite material thus formed is removed from the mold and cut, if necessary, so as to obtain the requisite boundary contours.

In the one-step process, there are two possibilities. According to the first method the two layers are heated up separately and then inserted into the mold on top of each other. The optimum heater temperature for the decorative skin is 180 to 200° C. for TPO and 150 to 180° C. for the carrier layer. According to the second method a laminate of the carrier layer and the decorative skin is first formed and the two sides thereof are then heated to the respective optimum temperature, e.g. by means of infrared radiation. In both methods the foils are placed into a mold preferably heated to about 60 to 100° C. and pressed together.

If a simple planar composite material is to be produced, it is sufficient to merely heat up the decorative skin to its softening temperature, place the same on the lower half of a flat compression mold, place the carrier layer onto it and press the parts together to form a composite.

It is important that the mold half which will come into contact with the decorative skin have a neatly polished surface so that the decorative skin of the composite material obtains a high-gloss surface. For this purpose, the surface of the mold may also be chromium plated.

The composite materials of the present invention can be used advantageously for lining of automotive outer parts, in particular of bumpers, but also of engine hoods, walls of campmobiles, luggage trunk lids, fuel tank caps and maintenance lids. In principle, automotive inner parts can also be lined therewith.

The materials of this invention, which have relatively good dimensional stability, can be mounted on automotive parts, for example by bolting together, clipping, sliding onto or adhesively bonding.

The composite materials stand out for their gloss and coloring, but also for their low weight, rigidity, resistance against cracking and shock, their weather and chemical resistance as well as for their acoustic and thermal insulation.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A composite material, comprising:
A) a carrier layer comprising a porous, fiber reinforced polyolefin with a thickness of 1 to 6 mm, and
B) a decorative skin comprising a deep-drawable, amorphous thermoplastic with a thickness of 0.5 to 5 mm.

2. The composite material of claim 1, wherein said carrier layer A consists of a polypropylene matrix containing 20 to 60 wt.-% glass fibers and having an air void content of 20 to 80 vol.-%.

3. The composite material of claim 1, wherein said decorative skin B consists essentially a blend of 95 to 50 wt.-% polypropylene and 5 to 50 wt.-% EPDM rubber.

4. The composite material of claim 1, wherein said decorative skin B is dyed or pigmented.

5. The composite material of claim 1, wherein said decorative skin B is coated with a protective film.

6. A method for producing a contoured part of a composite material of claim 1, comprising introducing a decorative skin into a first mold half; draping the carrier layer, heated to the melting temperature of the polyolefin, over said decorative skin, closing the mold and forming the composite material by pressing.

7. The method of claim 6, wherein the mold half that will come into contact with the decorative skin has a polished surface.

8. A method for producing a contoured part of a composite material comprising:
A) a carrier layer of a porous, fiber reinforced polyolefin with a thickness of 1 to 6 mm, and
B) a decorative skin of a deep-drawable, amorphous thermoplastic with a thickness of 0.5 to 5 mm, comprising heating the carrier layer up to the melting temperature of the polyolefin and heating the decorative skin up to the softening temperature of the amorphous thermoplastic, inserting the heated carrier layer and heated decorative skin into a mold, and bonding the carrier layer and deep-drawable, amorphous thermoplastic with each other under pressure.

9. The method of claim 8, wherein a mold half that contacts the decorative skin has a polished surface.

10. A method for producing a planar part of a composite material comprising:
A) a carrier layer of a porous, fiber reinforced polyolefin with a thickness of 1 to 6 mm, and
B) a decorative skin of a deep-drawable, amorphous thermoplastic with a thickness of 0.5 to 5 mm, comprising heating the decorative skin to its softening temperature and laying the decorative skin on a lower half of a flat compression mold, laying the carrier layer onto said decorative skin, and forming the composite material by pressing.

11. The method of claim 10, wherein the mold half that contacts the decorative skin has a polished surface.

12. The composite material of claim 1, which comprises a lining of an automotive outer part, in which said composite material is mounted on said automotive outer part.

13. A method of using a composite material comprising:
A) a carrier layer made of a porous, fiber reinforced polyolefin with a thickness of 1 to 6 mm, and
B) a decorative skin made of a deep-drawable, amorphous thermoplastic with a thickness of 0.5 to 5 mm,
a lining of an automotive outer part, in which method a part made of said composite material is mounted on said automotive outer part.

13. The composite material of claim 12, wherein the decorative skin is exposed on the exterior of said automotive outer part, and the decorative skin is optionally coated with a protective film.

14. The composite material of claim 1, which comprises a lining of an automotive bumper, wherein the composite material is mounted on said automotive bumper.

15. The composite material of claim 14, wherein the decorative skin is exposed on the exterior of said automotive bumper, and is optionally coated with a protective film.
